(19) United States
(12) Patent Application Publication
(10) Pub. No.: US 2003/0107963 A1
(43) Pub. Date: Jun. 12, 2003

(54) Optical disc apparatus

(75) Inventor: Takao Tani, Osaka (JP)

Correspondence Address: MORGAN LEWIS & BOCKIUS LLP, 1111 PENNSYLVANIA AVENUE NW, WASHINGTON, DC, 20004, US

(73) Assignee: FUNAI ELECTRIC CO., LTD.

(21) Appl. No.: 10/277,742

(22) Filed: Oct. 23, 2002

(30) Foreign Application Priority Data
Nov. 28, 2001 (JP) P 2001-363167

(51) Int. Cl. G11B 7/125

(52) U.S. Cl. 369/47.53

(57) ABSTRACT

In an optical disc apparatus in which data are recorded onto and reproduced from an optical disc 1 by an optical pickup 3, a system controller 10 records an execution result of power calibration in which a recording laser power is optimized, into an area in a main channel block of a PMA of an optical disc on which the power calibration is executed, the area being allocated to the manufacturer. In a subsequent recording process, the execution result of power calibration that is recorded in the manufacturer area is read out and is once stored into an SRAM 6 in the apparatus, and the recording laser power is determined on the basis of the stored execution result.

### BACKGROUND OF THE INVENTION

The present invention relates to an optical disc apparatus in which data are recorded onto and reproduced from an optical disc by an optical pickup.

In an optical disc apparatus, conventionally, an OPC (Optimum Power Control) is conducted on the recording laser power before data are recorded onto a write-once optical disc such as a CD-R. Namely, power calibration is previously executed to perform a trial write, thereby determining a laser power which is optimum for the subsequent recording.

The OPC is conducted by recording data at different recording laser powers into a PCA (Power Calibration Area) of an optical disc, and then reproducing the recorded data.

As shown in FIG. 2, a PMA (Program Memory Area) in which TOC data are temporarily stored is disposed inside a lead-in area which is in the inner periphery of the optical disc. The PCA is disposed inside the PMA.

The PCA is divided into a count area and a test area, and 100 sets of data can be written at the maximum into each of the areas. Namely, a trial write (power calibration) can be conducted 100 times.

A data indicative of the extent to which the test area is used is written into the count area. The test area is divided into 100 partitions each of which is configured by 15 frames. Namely, 15 frames are used in one trial write.

The laser power for a trail write is set to 15 levels ranging from “L” to “H” so that data are recorded into the respective frames at the respective laser power levels. Thereafter, the data are reproduced, and an optimum value of the laser power is determined from the laser power levels.

Conventionally, various techniques have been proposed as a method of executing such power calibration (for example, see the Unexamined Japanese Patent Application Publication Nos. Hei7-287847, 9-212866, 9-265628, and 11-353686). All of the techniques are those of conducting an OPC efficiently and effectively.

In such various conventional methods, data which are obtained as a result of execution of power calibration, i.e., data of the optimum value of a recording laser power are stored together with a code specific to the optical disc (disc specific code) into a memory medium disposed in an optical disc apparatus, such as an EEPROM or a flash ROM.

An OPC must be executed each time when a new optical disc is loaded and a recording process is then conducted. At each execution, therefore, a result of the execution of power calibration, i.e., data of the optimum value of a recording laser power for the optical disc are stored together with the disc specific code into the memory medium.

However, it is impossible to store all results of power calibration executed on various optical discs because the memory medium such as an EEPROM or a flash ROM has a limited capacity. Therefore, a conventional apparatus is configured so that, for example, 10 execution results of power calibration are stored at the maximum, and, when an eleventh execution result is input, the oldest result is erased and the newly input execution result of power calibration is then stored.

This causes a problem in that the number of execution results of power calibration which can be stored is limited. In the case where an optical disc on which recording is once conducted by an apparatus is again loaded into the apparatus to be subjected to recording, when the data of the optimum recording laser power value which should be stored in the memory medium has been already erased, power calibration must be again executed on the loaded optical disc, thereby causing a problem in that the PCA of the optical disc is wastefully consumed.

### SUMMARY OF THE INVENTION

The invention is conducted in order to solve the problems. It is an object of the invention to provide an optical disc apparatus in which a PCA of an optical disc can be prevented from being wastefully consumed, and a memory medium such as an EEPROM or a flash ROM for storing execution results of power calibration is not required.

According to the invention, in an optical disc apparatus in which data are recorded onto and reproduced from an optical disc by an optical pickup, an execution result of power calibration in which a recording laser power is optimized is recorded into an area in a main channel block of a PMA of an optical disc on which the power calibration is executed, the area being allocated to a manufacturer, and, in a subsequent recording process, the execution result of power calibration that is recorded in the manufacturer area is read out and is once stored into a buffer memory in the apparatus, and the recording laser power is determined on the basis of the stored execution result.

In a write-once optical disc, an area of about 800 bytes which is allocated to the manufacturer exists in a main channel block of a PMA. In the invention, attention is focused on the manufacturer area, and an execution result of power calibration is recorded together with an RID code (a recorded specific code of the apparatus) into the PMA. According to the configuration, it is not required to store the execution result of power calibration into the optical disc apparatus. Namely, a memory medium such as an EEPROM or a flash ROM for storing execution results of power calibration can be eliminated from the optical disc apparatus.

It is not necessary for the optical disc apparatus to hold execution results of power calibration. Unlike the conventional art, therefore, a situation where the number of stored execution results of power calibration is limited to, for example, 10 by the capacity of a memory medium such an EEPROM or a flash ROM does not occur.

Since the execution result of power calibration is stored on the optical disc itself, a situation in which power calibration is executed many times on the optical disc by the same optical disc apparatus does not occur. Therefore, wasteful consumption of the PCA of the optical disc can be eliminated.

Furthermore, according to the invention, in an optical disc apparatus in which data are recorded onto and reproduced from an optical disc by an optical pickup and a laser drive is included, an execution result of power calibration in which a recording laser power is optimized is recorded into a predetermined area of an optical disc on which the power calibration is executed. According to the configuration, a memory medium such as an EEPROM or a flash ROM for storing execution results of power calibration can be eliminated from the optical disc apparatus.

Moreover, the optical disc apparatus of the invention is characterized in that, in a recording process, the execution result of power calibration that is recorded in the predetermined area is read out and is once stored into a buffer memory in the apparatus, and the recording laser power is determined on the basis of the stored execution result.

In this case, a PMA is used as the predetermined area. Specifically, an area which is in an RID code of a main channel block of a PMA, and which is allocated to a manufacturer is used.

### BRIEF DESCRIPTION OF THE DRAWINGS

FIG. 1 is a block diagram showing the system configuration of the optical disc apparatus of the invention.

FIG. 2 is a diagram showing a data recording layout of an optical disc.

FIG. 3 is a view showing an example of the data configuration of a main channel block of a PMA.

FIG. 4 is a flowchart illustrating a process of executing an OPC.

FIG. 5 is a flowchart illustrating a process of reading from the PMA.

FIG. 6 is a flowchart illustrating a process of writing into the PMA.

### DETAILED DESCRIPTION OF THE PREFERRED EMBODIMENTS

Hereinafter, an embodiment of the invention will be described with reference to the accompanying drawings.

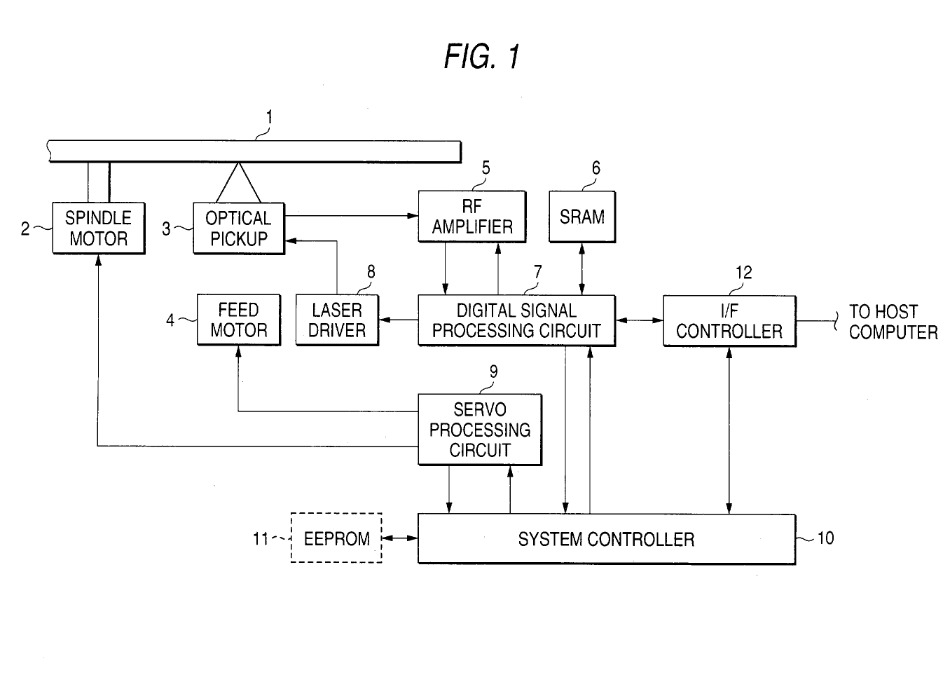

FIG. 1 is a system diagram of the optical disc apparatus of the invention.

An output of an optical pickup 3 which writes data onto an optical disc 1, and which reads written data is connected to a digital signal processing circuit 7 via an RF amplifier 5. An output of the digital signal processing circuit 7 is connected to a laser driver 8 which controls a laser output in the data writing and reading processes by the optical pickup 3. An output of a servo processing circuit 9 is connected to a feed motor 4 which moves the optical pickup 3 in a radial direction, and also to a spindle motor 2 which rotates the optical disc 1. The digital signal processing circuit 7 and the servo processing circuit 9 are bidirectionally connected to a system controller 10 which controls the whole apparatus.

An SRAM 6 serving as a buffer which temporarily stores data that are actually read from the optical disc 1 is bidirectionally connected to the digital signal processing circuit 7. An interface controller (I/F controller) 12 which is used for connecting the apparatus with a higher level host computer that is not shown is bidirectionally connected to the system controller 10 and the digital signal processing circuit 7.

In a conventional optical disc apparatus, for example, an EEPROM (or a flash ROM or the like) 11 for storing data of the optimum value of a recording laser power which is obtained as an execution result of power calibration is connected to the system controller 10 as indicated by the broken line in the figure. By contrast, the optical disc apparatus of the invention has a configuration in which a memory medium such as the EEPROM 11 is omitted.

The digital signal processing circuit 7 performs processes such as those of dividing a 16-bit signal into 8-bit portions and converting the 8 bits into 14 bits in accordance with EFM modulation/demodulation or an error correcting method based on a CIRC (Cross Interleaved Reed-Solomon Code).

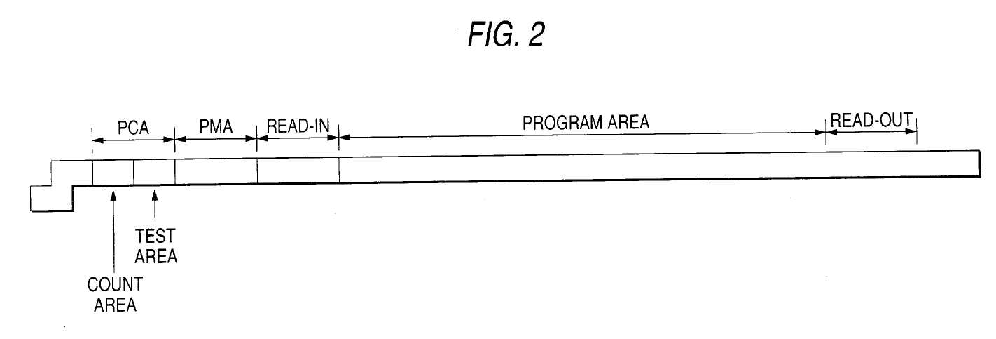

In advance of recording of data onto the loaded optical disc 1, the system controller 10 executes power calibration in which the recording laser power is optimized. Then, a result of the execution (i.e., data of the optimum value of the recording laser power) is recorded together with an RID code (a specific code of the optical disc apparatus) into a manufacturer area of a main channel block of a PMA (see FIG. 2) of the optical disc 1. In a data recording process which is subsequently executed, the execution result of power calibration (i.e., the data of the optimum value of the recording laser power) which is recorded in the manufacturer area of the main channel block of the PMA is read out and is once stored in the SRAM 6 serving as a buffer memory in the apparatus, and the recording laser power is determined on the basis of the stored data of optimum value of the recording laser power.

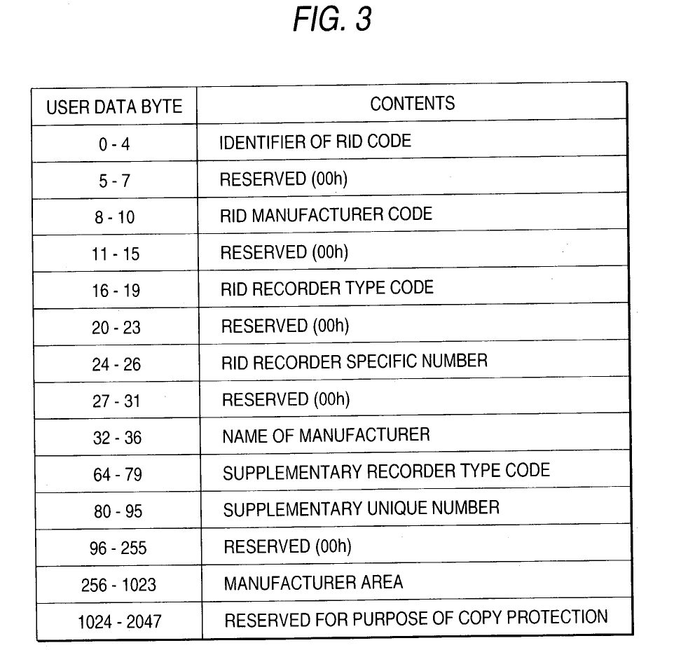

FIG. 3 shows an example of the data configuration of the main channel block of the PMA.

The main channel block is configured by: an identifier of the RID code (0th to 4th bytes); an RID manufacturer code (8th to 10th bytes); an RID recorder type code (16th to 19th bytes); an RID recorder specific number (24th to 26th bytes); the name of the manufacturer (32nd to 63rd bytes); the manufacturer area (256th to 1,023rd bytes); etc. The manufacturer can freely use the area of about 800 bytes allocated to the manufacturer. In the invention, therefore, the data of the optimum value of the recording laser power are recorded into the manufacturer area (256th to 1,023rd bytes).

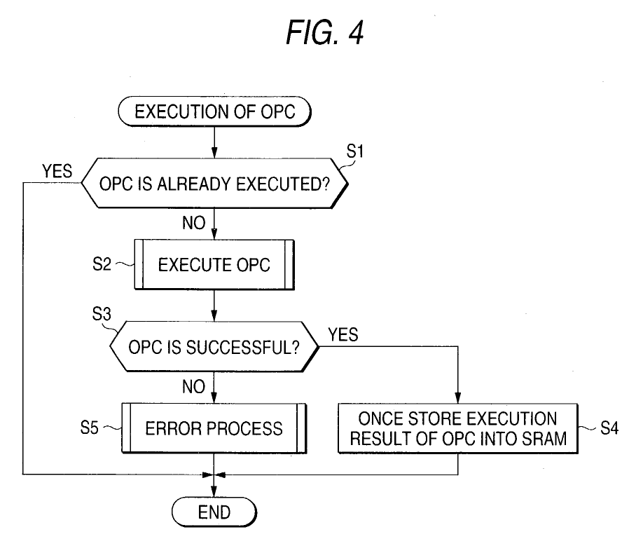

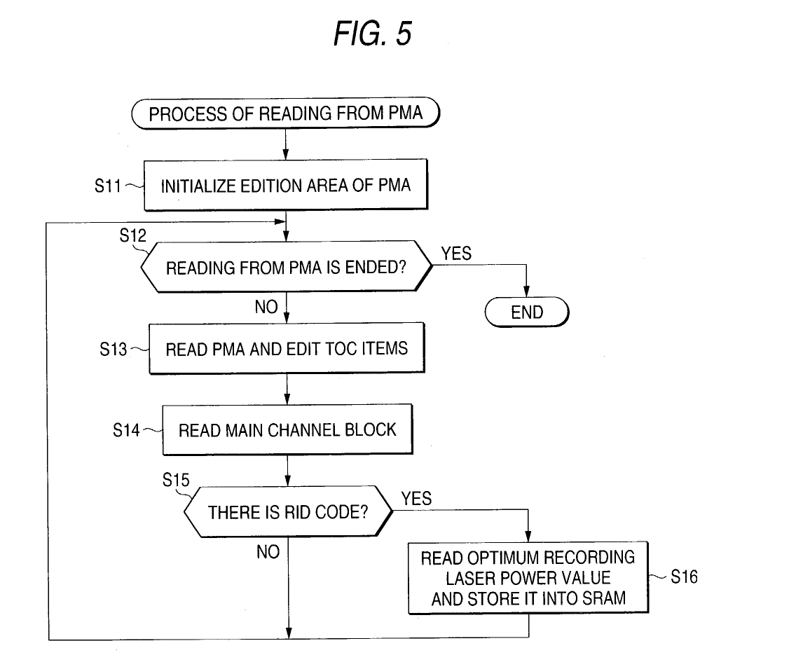

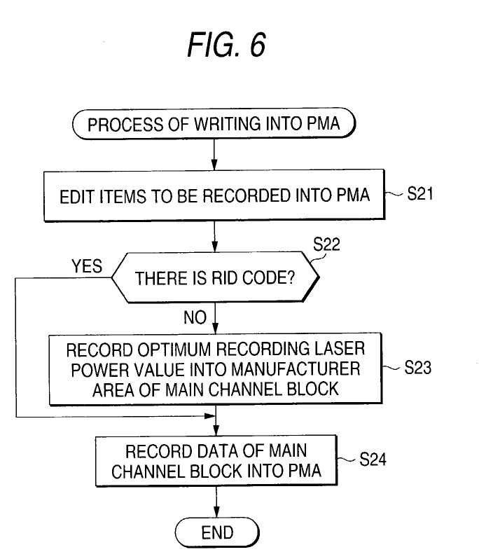

Next, a series of processes from loading of the optical disc 1 into the apparatus main unit to start of recording in the thus configured optical disc apparatus will be described with reference to flowcharts shown in FIGS. 4 to 6. FIG. 4 is a flowchart illustrating a process of executing the OPC, FIG. 5 is a flowchart illustrating a process of reading from the PMA, and FIG. 6 is a flowchart illustrating a process of writing into the PMA.

First, the optimum power control (OPC) of the recording laser power will be described with reference to the flowchart shown in FIG. 3.

(1) Process of Executing OPC

In the process of executing the OPC, the system controller 10 reads out TOC (Table of Contents) data recorded in the lead-in area of the loaded optical disc 1, and checks whether the data contain an RID code or not (step S1). If the data contain the RID code of the apparatus itself (Yes in step S1), it indicates that the optical disc 1 has been already subjected to the OPC, and hence the process is ended.

By contrast, if the data do not contain the RID code of the apparatus itself (the judgement in step S1 is No), the OPC is executed (step S2).

First, the count area of the PCA shown in FIG. 2 is read to know the starting position of writing into the test area. In the known test area, while setting the laser power for a trial write to 15 levels ranging from “L” to “H”, data are recorded into the respective frames at the respective laser power levels. Thereafter, the recorded data are reproduced, and an optimum laser power value is determined from the laser power levels.

If the OPC is executed and the optimum laser power value can be determined in this way (the judgement in step S3 is Yes), the data of the highest laser power level which is obtained as a result of the execution of the OPC is once stored into the SRAM 6 in the apparatus (step S4). By contrast, if the OPC is not normally executed, an error process is conducted (step S5).

(2) Process of Reading from PMA

In the process of reading from the PMA, the system controller 10 initializes an edition area of the PMA which is in the inner peripheral side of the optical disc 1 (step S11), the PMA is then read, and TOC items are edited (to step S13 via step S12). Next, the data of the main channel block shown in FIG. 3 are read out (step S14). Then, it is judged whether there is the own RID code in the main channel block or not (step S15).

If there is the RID code, the data of the optimum recording laser power value which is recorded in the manufacturer area in accordance with this code is read out, and is stored into the SRAM 6 in the apparatus (step S16). This processing is conducted until the reading from the PMA is completed (until the judgement in step S12 becomes No). Thereafter, the recording laser power of the optical pickup 3 is set to the optimum value stored in the SRAM 6, and data are then recorded onto the optical disc 1.

(3) Process of Writing into PMA

In the process of writing into the PMA, the system controller 10 edits items to be recorded into the PMA (step S21), then reads out the data of the main channel block, and judges whether there is the own RID code in the main channel block or not (step S22).

If the RID code is not in the block, the OPC is executed in the step. The data of the optimum recording laser power value which has been obtained as a result of execution of the OPC is stored in step S4 into the SRAM 6 in the apparatus. At this timing, therefore, the optimum recording laser power value stored in the SRAM 6 is recorded into the manufacturer area of the main channel block (step S23), and the main channel is recorded into the PMA (step S24).

The optical disc apparatus of the invention is configured so that an execution result of power calibration in which a recording laser power is optimized is recorded into an area in a main channel block of a PMA of an optical disc on which the power calibration is executed, the area being allocated to the manufacturer, and, in a subsequent recording process, the execution result of power calibration that is recorded in the manufacturer area is read out and is once stored into a buffer memory of the apparatus, and the recording laser power is determined on the basis of the stored execution result. Namely, an execution result of power calibration is recorded together with an RID code into the PMA, thereby eliminating the necessity of storing execution results of power calibration into the optical disc apparatus. Therefore, a memory medium such as an EEPROM or a flash ROM which is used in the conventional art can be omitted from the optical disc apparatus.

The optical disc apparatus is not required to hold execution results of power calibration. Unlike the conventional art, therefore, a situation where the number of stored execution results of power calibration is limited to, for example, 10 by the capacity of a memory medium such an EEPROM or a flash ROM does not occur.

Since the execution result of power calibration is stored on the optical disc itself, a situation in which power calibration is executed many times on the optical disc by the same optical disc apparatus does not occur. Therefore, wasteful consumption of the PCA of the optical disc can be eliminated.

What is claimed is:

1. An optical disc apparatus comprising:
an optical pickup for reproducing a data recorded onto an optical disc, and
a buffer memory, wherein
an execution result of power calibration in which a recording laser power is optimized is recorded into an area in a main channel block of a PMA of the optical disc on which the power calibration is executed, said area being allocated to a manufacturer,
in a subsequent recording process, the execution result of power calibration recorded in said manufacturer area is read out, and is once stored into said buffer memory, and
the recording laser power is determined on the basis of the stored execution result.

2. An optical disc apparatus comprising:
an optical pickup for reproducing data recorded onto an optical disc, and
a laser driver, wherein
an execution result of power calibration in which a recording laser power is optimized is recorded into a predetermined area of the optical disc on which the power calibration is executed.

3. The optical disc apparatus according to claim 2, further comprising:
a buffer memory, wherein
in a recording process, the execution result of power calibration recorded in said predetermined area is read out, and is once stored into said buffer memory, and
the recording laser power is determined on the basis of the stored execution result.

4. The optical disc apparatus according to claim 2, wherein
said predetermined area is a PMA.

5. The optical disc apparatus according to claim 2, wherein
said predetermined area is an area in an RID code of a main channel block of a PMA, said area being allocated to a manufacturer.
[FIG. 1]

| | |
|---|---|
| 2 | SPINDLE MOTOR |
| 3 | OPTICAL PICKUP |
| 4 | FEED MOTOR |
| 5 | RF AMPLIFIER |
| 7 | DIGITAL SIGNAL PROCESSING CIRCUIT |
| 8 | LASER DRIVER |
| 9 | SERVO PROCESSING CIRCUIT |
| 10 | SYSTEM CONTROLLER |
| 12 | I/F CONTROLLER |
| A | TO HOST COMPUTER |

[FIG. 2]

| | |
|---|---|
| A | LEAD-IN |
| B | PROGRAM AREA |
| C | LEAD-OUT |
| D | COUNT AREA |
| E | TEST AREA |

[FIG. 3]

| | |
|---|---|
| A | USER DATA BYTE |
| B | CONTENTS |
| C | IDENTIFIER OF RID CODE |
| D | RESERVED (00h) |
| E | RID MANUFACTURER CODE |
| F | RESERVED (00h) |
| G | RID RECORDER TYPE CODE |
| H | RESERVED (00h) |
| I | RID RECORDER SPECIFIC NUMBER |
| J | RESERVED (00h) |
| K | NAME OF MANUFACTURER |
| L | SUPPLEMENTARY RECORDER TYPE CODE |
| M | SUPPLEMENTARY UNIQUE NUMBER |
| N | RESERVED (00h) |
| O | MANUFACTURER AREA |
| P | RESERVED FOR PURPOSE OF COPY PROTECTION |

[FIG. 4]

| | |
|---|---|
| A | EXECUTION OF OPC |
| S1 | OPC IS ALREADY EXECUTED? |
| S2 | EXECUTE OPC |
| S3 | OPC IS SUCCESSFUL? |
| S4 | ONCE STORE EXECUTION RESULT OF OPC INTO SRAM |
| S5 | ERROR PROCESS |
| B | END |

[FIG. 5]

| | |
|---|---|
| A | PROCESS OF READING FROM PMA |
| S11 | INITIALIZE EDITION AREA OF PMA |
| S12 | READING FROM PMA IS ENDED? |
| B | END |
| S13 | READ PMA AND EDIT TOC ITEMS |
| S14 | READ MAIN CHANNEL BLOCK |
| S15 | THERE IS RID CODE? |
| S16 | READ OPTIMUM RECORDING LASER POWER VALUE AND |
| | STORE IT INTO SRAM |

[FIG. 6]

| | |
|---|---|
| A | PROCESS OF WRITING INTO PMA |
| S21 | EDIT ITEMS TO BE RECORDED INTO PMA |
| S22 | THERE IS RID CODE? |
| S23 | RECORD OPTIMUM RECORDING LASER POWER VALUE |
| | INTO MANUFACTURER AREA OF MAIN CHANNEL BLOCK |
| S24 | RECORD DATA OF MAIN CHANNEL BLOCK INTO PMA |
| B | END |
